(19) United States
(12) Patent Application Publication
(10) Pub. No.: US 2003/0226970 A1
(43) Pub. Date: Dec. 11, 2003

(54) Infrared spectral sources

(76) Inventor: Shaul Yatsiv, Jerusalem (IL)

Correspondence Address: Weisz Tiberiu, Gottlieb Rackman & Reisman, 270 Madison Avenue, New York, NY, 10016-0601, US

(21) Appl. No.: 10/276,791

(22) PCT Filed: May 21, 2001
(86) PCT No.: PCT/IL01/00452

(30) Foreign Application Priority Data
May 22, 2000 (IL) 136291

(51) Int. Cl. G01J 5/02

(52) U.S. Cl. 250/341.6; 250/493.1; 356/311

(57) ABSTRACT

An infrared (IR) radiation source (20, 50) includes an envelope (22), at least a portion (26) of which is IR transmissive, and a molecular gas species (23), contained in the envelope, which gas species is thermally excited to emit IR radiation in a discrete spectrum characteristic of the species, substantially without heating the envelope.

### FIELD OF THE INVENTION

The present invention relates generally to molecular spectroscopy, and specifically to infrared molecular spectral radiation sources.

### BACKGROUND OF THE INVENTION

Infrared radiation (IR) sources are widely used in molecular spectroscopy and gas analysis, as well as other applications. Typically, the concentration of a gas of interest in a sample is determined by measuring the sample's IR absorption of radiation emitted by a source in a characteristic absorption band of the gas of interest. Such IR sources fall generally info the categories of thermal sources and discrete band sources.

Thermal sources known in the art commonly comprise black-body or gray-body sources. Such sources emit radiation having a continuous spectrum, generally following the well-known Planck distribution. This continuous spectrum is a poor match for typical molecular absorption spectra, which comprise discrete lines in specific spectral regions. As a result, IR absorption measurements using thermal sources generally have a low signal/background ratio and may be confused by the presence of other gases in the sample that absorb in the same spectral region as the gas of interest. Although the source spectrum may be filtered to reduce the background and limit the radiation to a specific spectral region, the match between the continuous spectrum of the source and the discrete line spectrum of the gas of interest remains poor.

U.S. Pat. No. 5,300,859, to Yatsiv, which is incorporated herein by reference, describes discrete IR spectral sources. These sources operate by passing an RF discharge through a sealed volume of gas, including a molecular species of interest, such as CO₂. The gas is excited by the discharge to emit IR radiation at discrete lines, characteristic of the vibrational/rotational spectrum of the molecular species. When this discrete line radiation is passed through a sample that includes the species of interest, it will be strongly and specifically absorbed, giving a high signal/background ratio. The spectral lines emitted by such lamps are sufficiently narrow and specific to be used even in distinguishing between different isotopes of the same species, for example, ¹⁴CO₂ and ¹³CO₂. The RF discharge excites the gas without substantially heating the envelope in which the gas in contained, so that there is relatively little thermal radiation background to interfere with the line spectrum.

Unfortunately, it has been found that most molecular gases break down under the RF discharge, so that the technique of the above-mentioned patent requires a flowing gas supply and can be used to make sealed-off lamp sources based on only a few molecular species, such as CO₂, CO and hydrogen halides, that recombine to the original molecule after being dissociated in the electric discharge. Therefore, this technique is not practically applicable to most gases of interest. Other gas excitation techniques known in the art tend to heat the IR-transparent envelope containing the gas, so that the continuous thermal spectrum emitted by the envelope overwhelms the discrete line spectrum of the gas, and the specificity of the source is lost.

John Tyndall, in an article entitled “On the Absorption and Radiation of Heat by Gaseous and Liquid Matter,” in Fragments of Science (Longmans, Green and Co., 1879), pp. 165-193, which is incorporated herein by reference, described experiments in which various gases were excited to emit radiation by rapid heating. In one set of experiments, a sample gas was heated by flowing against a heated metal foil and then released at a moderate rate into the atmosphere. As a result, a laminar stream of hot test gas flowed undisturbed through the surrounding, cold, atmospheric air. It was observed, using a thermal detector, that the hot gas emitted IR radiation. In other experiments, the gas was heated by flowing into an evacuated chamber, and was similarly observed to emit IR radiation. By introducing another (unexcited) sample of the same gas between the chamber and the detector, Tyndall discovered that the emitted radiation was strongly absorbed by the gas.

### SUMMARY OF THE INVENTION

It is an object of the present invention to provide improved IR spectral sources.

It is an object of some aspects of the present invention to provide IR sources based on a closed volume of gas, so that a flowing gas supply is generally not required.

It is another object of some aspects of the present invention to provide IR sources that emit discrete line spectra, characteristic of various molecular gas species. Preferably, infrared radiation from the sources other than desired discrete line spectra, including broadband thermal radiation therefrom, is minimized.

It is a further object of some aspects of the present invention to provide methods for generating discrete IR spectral radiation.

In preferred embodiments of the present invention, an IR source comprises an envelope containing a molecular gas species. A rapid increase in temperature is applied to the gas in the envelope, exciting the gas so that it emits IR radiation in a spectrum that is characteristic of the species, preferably of the vibration/rotational line emission spectrum of the molecules in the species. The envelope is only minimally heated, so that the broadband thermal radiation emitted by the source does not increase substantially relative to ambient thermal emission. The IR radiation emitted by the gas passes out of the envelope through a suitable IR-transmitting window.

In some preferred embodiments of the present invention, the IR radiation emitted by the IR source is used in non-dispersive IR (NDIR) testing of a gas sample. The gas sample typically includes an unknown concentration of the molecular species, and the absorption of the radiation emitted from the IR source is measured to determine the concentration of the species in the sample. The IR source of the present invention is particularly advantageous for this purpose, since the radiation it emits will be absorbed preferentially by the molecular species, with far less absorption by gas molecules of any other type. The sample whose absorption is being measured may be enclosed in a cell with IR transparent windows or, alternatively, may comprise a flowing stream of gas or even ambient air. Preferably, although not necessarily, the radiation from the source is modulated, for example, by optical chopping, or by alternate heating and cooling, as described below, and the absorption is measured synchronously with the modulation, as is known in the art.

In some preferred embodiments of the present invention, the gas in the envelope is heated by adiabatic compression. The envelope is filled with the molecular species, preferably in mixture with a buffer gas, such as argon, and is preferably closed off after filling. Preferably, the volume of the gas in the envelope is alternately reduced and increased, for example, by the action of a piston. This alternating reciprocation cycle causes the temperature of the gas to increase and decrease rapidly, without substantially heating the envelope and without causing substantial decomposition of the molecular species or heating of the envelope. Alternatively, the volume of the envelope is held fixed, while the pressure of the gas is increased and decreased, by rapidly opening and closing pressurization and evacuation valves, for example.

In other preferred embodiments of the present invention, other methods of thermal excitation of the gas may be used. For example, the gas may be flowed through the cooled envelope, after having been heated by conductive heating. The gas in the envelope thus emits the characteristic IR radiation of the molecular species therein, without substantial heating of the envelope. In any case, IR sources in accordance with the present invention, unlike sources known in the art, do not generally use an electrical discharge to excite the gas. In this manner, decomposition of the molecular species is eliminated or at least reduced, so that the useful lifetime of the gas in the envelope is extended and the range of species that can be used in such sources is substantially greater than in sealed discharge-excited sources.

In some preferred embodiments of the present invention, a gas spectrograph comprises an IR source of the type described herein, together with an IR spectrum analyzer. The spectrograph is used to generate and analyze emission spectra of gas samples. A gas sample to be analyzed, whose composition may be known or unknown, is introduced into the envelope of the IR source and is caused to emit its characteristic spectral radiation, as described above. The spectrum analyzer, which may be of any suitable type known in the art, separates the radiation into its spectral components. A detector coupled to the spectrum analyzer outputs a line or band spectrum of the radiation. This line spectrum may be displayed and/or processed in order to provide qualitative and quantitative information regarding the composition of the gas sample.

There is therefore provided, in accordance with a preferred embodiment of the present invention, an infrared (IR) radiation source, including:

an envelope, at least a portion of which is IR transmissive; and

a molecular gas species, contained in the envelope, which gas species is thermally excited to emit IR radiation in a discrete spectrum characteristic of the species, substantially without heating the envelope.

Preferably, the species is excited substantially without applying an electrical discharge thereto, and the envelope is closed off, so that gas does not flow into or out of the envelope during the excitation of the species.

In a preferred embodiment, the envelope contains a buffer gas, mixed with the molecular gas species. Preferably, the buffer gas includes a rare gas, most preferably argon. Further preferably, the buffer gas is mixed with the molecular gas species in a ratio of approximately 10:1.

Preferably, the molecular gas species is excited by adiabatic compression of the gas in the envelope, wherein the gas is alternately compressed and expanded, whereby the molecular gas species emits pulses of IR radiation. In a preferred embodiment, the envelope includes a piston, which compresses the gas. In another preferred embodiment, the envelope includes a rotating cylindrical valve, which alternately admits the gas into the envelope at a high pressure so as to compress the gas in the envelope and permits the gas to exit the envelope at a low pressure. Preferably, the gas is compressed by a ratio of at least 5:1, and the gas in the envelope is compressed and expanded multiple times.

Preferably, the IR radiation emitted by the source is temporally modulated.

In an alternative embodiment, the gas species is thermally excited by conductive heating of the gas. In a further alternative embodiment, the molecular gas species includes a plurality of different types of molecules, which are thermally excited to emit different, respective IR emission spectra.

There is also provided, in accordance with a preferred embodiment of the present invention a method for generating IR radiation, including:

filling an envelope, at least a portion of which is IR transmissive, with a molecular gas species; and

thermally exciting the gas species to emit IR radiation in a discrete spectrum characteristic of the species, substantially without heating the envelope.

In a preferred embodiment, exciting the species includes reciprocally compressing and decompressing the gas multiple times. In another preferred embodiment, admitting the gas to an envelope at a high pressure and allowing the gas to exit the envelope at a low pressure.

In a further preferred embodiment, filling the envelope includes filling the envelope with a species that is substantially isotopically pure, whereby the emitted IR radiation is used to discriminate between isotopic variants of the species.

There is additionally provided, in accordance with a preferred embodiment of the present invention, apparatus for generating infrared (IR) emission, including:

a cylindrical envelope, at least a portion of which is IR transmissive, the envelope having at least one inlet port in an outer surface thereof, coupled to a source of a gas at a high pressure, and at least one outlet port in the outer surface thereof, coupled to allow the gas to exit the envelope at a low pressure; and

a cylindrical valve mounted to rotate coaxially within the envelope, the valve having at least one inlet hole and at least one outlet hole, such that as the valve rotates, the inlet and outlet holes are respectively brought into alignment with the inlet and outlet ports in alternation, so as alternately to admit the gas to the envelope through the inlet port and to allow the gas to exit through the outlet port, thereby thermally exciting the gas to emit IR radiation.

Preferably, the apparatus includes a high-pressure reservoir, which serves as the source of the gas, a low-pressure reservoir, coupled to the at least one outlet port of the envelope, and a compressor, coupled to transfer the gas from the low-pressure reservoir to the high-pressure reservoir, whereby the gas circulates through the apparatus in a closed circuit.

There is further provided, in accordance with a preferred embodiment of the present invention, an infrared (IR) spectrograph, including:

an IR source, including:

an envelope, at least a portion of which is IR transmissive, and which is adapted to contain a molecular gas species; and

a thermal excitation mechanism, adapted to thermally excite the gas in the envelope to emit IR radiation in a discrete spectrum including multiple spectral lines characteristic of the species; and

a spectrometer, coupled to receive the IR radiation emitted by the molecular gas species in the envelope and to separate the spectral lines in the radiation so as to derive an emission spectrum of the species.

Preferably, the spectrometer includes a wavelength—dispersive device. Alternatively, the spectrometer includes an interferometric device.

There is moreover provided, in accordance with a preferred embodiment of the present invention, a method for infrared (IR) spectral analysis of a molecular gas species, including:

filling an envelope, at least a portion of which is IR transmissive, with the molecular gas species;

thermally exciting the gas species in the envelope to emit IR radiation in a discrete spectrum including multiple spectral lines characteristic of the species; and

separating the spectral lines in the emitted radiation so as to derive an emission spectrum of the species.

There is moreover provided, in accordance with a preferred embodiment of the present invention, an infrared (IR) radiation source, including:

an envelope, at least a portion of which is IR transmissive, and which is adapted to contain a gas that includes a molecular gas species; and

an excitation mechanism, coupled to the envelope so as to thermally excite the gas, causing the species to emit IR radiation in a discrete spectrum characteristic of the species, substantially without heating the envelope.

The present invention will be more fully understood from the following detailed description of the preferred embodiments thereof, taken together with the drawing in which:

### BRIEF DESCRIPTION OF THE DRAWING

FIG. 1 is a schematic, sectional illustration showing an IR source, in accordance with a preferred embodiment of the present invention;

FIG. 2 is a schematic, partly sectional illustration showing an IR source, in accordance with another preferred embodiment of the present invention; and

FIG. 3 is a block diagram that schematically illustrates an IR spectrograph, in accordance with a preferred embodiment of the present invention.

### DETAILED DESCRIPTION OF PREFERRED EMBODIMENTS

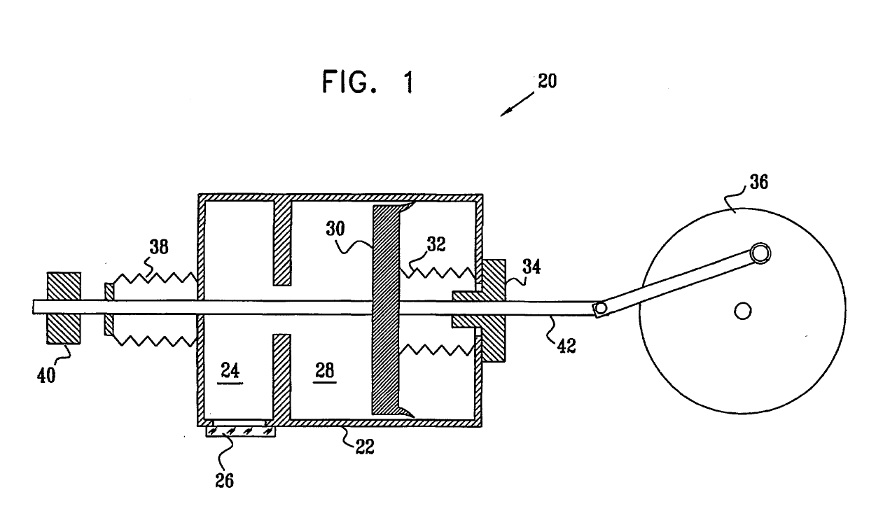

Reference is now made to FIG. 1, which is a schematic, sectional illustration showing an IR source 20, in accordance with a preferred embodiment of the present invention. Source 20 comprises an envelope 22, including a compression chamber 24 and a reserve chamber 28. An IR-transmitting window 26 is disposed at one or both sides of the compression chamber. The envelope is preferably cylindrical in shape, made of stainless steel, having a diameter of about 2 cm and a height of about 5 cm. The window preferably comprises optical sapphire, calcium fluoride or KRS5, having a diameter of about 2 cm and a thickness of about 3 mm. These dimensions are given only by way of example, however, and IR sources in accordance source 20 is substantially free of thermal radiation background emission of the envelope or other parts of the source, beyond normal ambient thermal radiation.

Source 20 thus emits a substantially pure, narrow-band vibrational/rotational line spectrum of the molecular species, without the need for further filtering of the emitted radiation. The emission of source 20 is temporally modulated, at the reciprocation rate of the piston, and can therefore be more easily distinguished from the background thermal emission, which is substantially continuous and not modulated. Preferably, the initial gas pressure and the piston compression ratio are set depending on the desired emission spectrum, as well as mechanical and thermodynamic constraints of source 20. Compression ratios in the range of 5:1 to 10:1 have been found to be useful. The intensity of emission of the spectrally-discrete thermal radiation is different for different molecules and depends on the frequency of the emitted band and the strength of the molecular transition giving rise to the band. Preferably, the compression ratio is chosen so as to optimize the intensity of the relevant emission band.

A further advantage of source 20 is that the adiabatic compression of the gas in envelope 22 causes relatively little decomposition of the gas molecules. In discharge-excited sources known in the art, it has been found that nearly all molecular gases decompose rapidly under the influence of the discharge. With only a few exceptions, such as CO₂ and CO, when the decomposition products recombine, they form molecules different from the original species, which is thus rapidly depleted. Therefore, a flowing gas supply must be used to sustain molecular radiation in most species. By contrast, the present inventors have found that adiabatic compression in accordance with the principles of the present invention can be used to produce sources of narrow-band vibrational/rotational line spectra of substantially any volatile, IR active molecular species. By suitable choice of the gas pressure and concentration in envelope 22, as well of the compression ratio and reciprocation rate of piston 30, source 20 can be made to operate in a sealed-off mode for an extended period.

Preferably, source 20 is used to irradiate a sample of gas (not shown in the figures) adjacent to window 26, in order to determine the composition of the sample. Typically, absorption of the radiation from the source that passes through the sample is measured so as to determined the concentration in the sample of the same molecular species that is contained in the envelope. Because of the reciprocating action of piston 30, the radiation emitted by source 20 is pulsed, with a pulse rate and duty cycle determined by the motion of the piston. Preferably, the absorption is measured synchronously with the pulse rate and duty cycle of the source, in order to increase the signal/noise ratio and specificity of detection. Alternatively, an optical chopper or other means known in the art may be used for this purpose to modulate the IR radiation emitted by the source. Generally speaking, sources in accordance with the principles of the present invention allow highly specific detection of even very low concentrations of molecular gases in both closed and flowing gas samples. Such sources can also be made using an isotopically pure molecular species in the envelope, so that the concentration of one isotopic variant of the species in the sample can be distinguished from another.

When source 20 is used in discriminating between different molecular species, attention must generally be given to the extent of overlap between the molecular absorption bands of the different species. The overlap depends generally on the molecular weights, i.e., on the moments of inertia of the molecules. The overlap is therefore typically smallest for light molecules. For this reason, when band selectivity is important, the emitting molecular species used in source 20 preferably has a molecular weight no greater than about 100. This limit can be relaxed, however, when there is not a problem of band overlap. Furthermore, when a problem of overlap does occur, a suitable gas filter can be introduced between the source and the test sample, in order to filter out radiation on the overlapping lines of the species whose detection is not of interest. Spectral overlap is generally more severe in mid-IR bands that are due to stretching vibrations of the molecules in question than in far-IR bands (typically greater than 10 μm wavelength) due to bending vibrations. Therefore, as a further alternative for discriminating between species, particularly heavier molecules whose mid-IR spectra overlap, source 20 may be provided with suitable optics for far-IR generation, and may be used in conjunction with suitable far-IR detectors, as are known in the art.

The likelihood for overlap of discrete spectral lines of two different molecules depends on two main factors:

1. The characteristic frequency separation between adjacent vibrational-rotational components that make up a spectral band. As noted above, this frequency separation is inversely proportional to the moment of inertia of the molecule.

2. Broadening of the spectral lines in the band.

When the interline separation is large compared to the linewidth, the probability of accidental coincidence between the spectra of different molecules is relatively small. For this reason, in determining the mixture and pressure of gases in source 20, it is important to consider the effects of line broadening mechanisms. Doppler broadening of the lines increases with temperature. For light molecules (molecular weight less than about 50 or 60) at moderate temperatures (less than about 500° C.), Doppler broadening does not significantly blur the spectral lines. Pressure broadening, due to collisions between the gas molecules, increases with gas pressure. It generally leads to complete smearing of the spectral lines at 10 atm and above. Below about 5 torr, however, Doppler broadening is dominant at ambient temperatures. In any case, the optimal mixture and pressure parameters are a function of the type of gas molecule, system sensitivity requirements and the quality and sophistication of the associated IR detection apparatus.

In a preferred embodiment of the present invention, source 20 is used for distinguishing between different isotopes of the same species, such as ¹⁴CO₂ and ¹³CO₂, as described generally in the above-mentioned U.S. Pat. No. 5,300,859. For this application, it is desirable to fill envelope at sufficiently low pressure to ensure that the spectral lines of the different isotopic species do not substantially overlap.

In another preferred embodiment, source 20 is used to generate emission spectra of two or more different molecule species simultaneously. By mixing the different species in envelope 22 at appropriate pressures, discrete band spectra are generated for all of them. All are subject to the same adiabatic reciprocation cycles and run at the same frequency. There is no theoretical limit to the number of different species that can be used, although clearly there will be practical limits. When more than one gas is compressed, a filter can be inserted to transmit the characteristic band spectrum of a single gas constituent at a time.

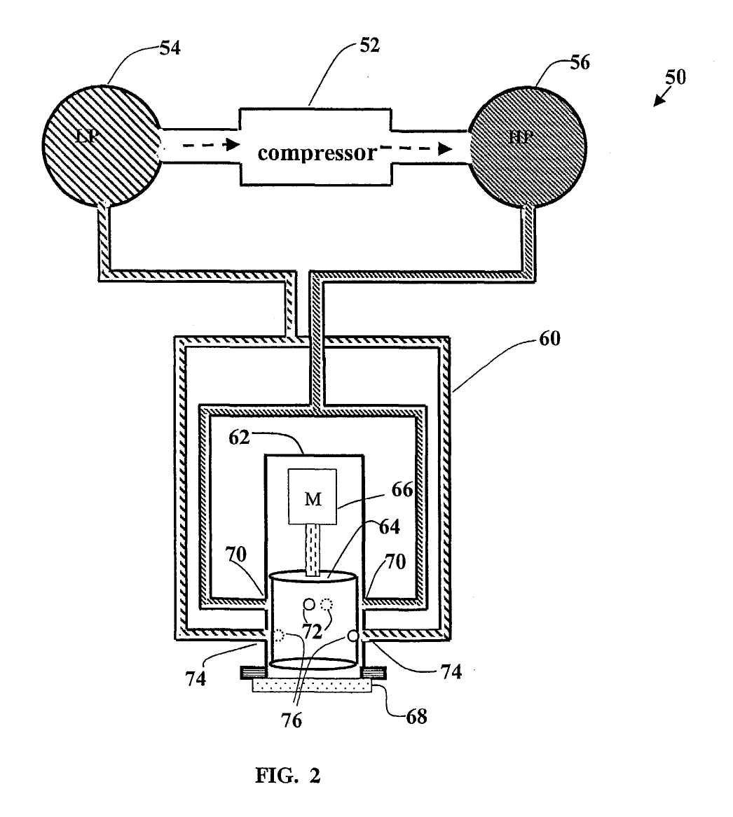

FIG. 2 is a schematic, partly sectional illustration of an IR source 50, in accordance with another preferred embodiment of the present invention. Source 50 operates by adiabatically increasing and decreasing the pressure of an IR-active gas in an envelope 62, without substantially changing the volume of the envelope as in source 20 (FIG. 1). As described in greater detail below, source 50 uses rotational motion to vary the gas pressure, instead of the reciprocating motion of source 20. In terms of its physical principles of operation and range of applications, however, source 50 is substantially analogous to source 20, and the description above of these principles and applications is likewise applicable to source 50 except where specified otherwise.

Source 50 comprises a closed-circuit gas flow system, driven by a compressor 52. The compressor draws the gas from a low-pressure vessel 54 to a high-pressure vessel 56. Preferably, the ratio of pressures between the high- and low-pressure vessels is at least 10:1. The gas pressure in envelope 62 is varied by an alternating cylindrical valve 64. The valve rotates under the power of a motor 66, which is preferably contained inside envelope 62. Valve 64 operates in alternation to admit the gas into the envelope from high-pressure vessel 56 and to allow the gas to exit the envelope into low-pressure vessel 54. The pressure variations in the envelope cause the gas to emit its characteristic IR spectral radiation, which passes out of the envelope through an IR window 68.

Cylindrical valve 64 rotates coaxially inside envelope 62 (which is also cylindrical) with minimal play and vibration. Preferably, the outer diameter of the cylindrical valve is only slightly less than the inner diameter of the envelope. In a preferred embodiment, the inner diameter of the envelope is approximately 30 mm, and the outer diameter of the envelope is 0.03 mm smaller than the inner diameter of the envelope. In this embodiment, the valve rotates at a speed of 50-100 rotations per second. The optical clear aperture of window 68 is preferably approximately 12 mm.

Envelope 62 comprises high-pressure inlet ports 70 connected to high-pressure reservoir 56, and low-pressure outlet ports 74 connected to low-pressure reservoir 54. In the embodiment shown in FIG. 2, there are two diametrically-opposed inlet ports 70 in mutual axial alignment at one axial location, and two diametrically-opposed outlet ports 74 in mutual axial alignment at another axial location. Valve 64 comprises a pair of diametrically-opposed inlet holes 72 at an axial location aligned with inlet ports 70, and a pair of diametrically-opposed outlet holes 76, at an axial location aligned with outlet ports 74. The holes and ports are preferably about 5 mm in diameter. The inlet and outlet holes are mutually displaced by approximately 90° about the longitudinal axis of valve 64. Thus, as valve 64 rotates within envelope 62, holes 72 are periodically brought into alignment with ports 70, thus allowing entry of the gas into the envelope at high pressure, and then holes 76 are brought into alignment with ports 74, so as to partially evacuate the envelope. The cyclic pressure variations that are generated in the envelope in this manner, twice per rotation, adiabatically heat and cool the gas, causing it to emit radiation through window 68.

Although FIG. 2 shows a particular arrangement of ports 70, 74 and holes 72, 76, it will be apparent to those skilled in the art that different numbers and arrangements of ports and holes may similarly be used. By changing the sizes, number and positions of the holes, it is possible to vary the duty cycle, repetition rate and pressure range of source 50. Preferably, optics that are used in conjunction with source 50 (not shown) are arranged so that radiation from the area of holes 72 and 76 does not impinge on a detector used to sense the radiation from source 50, since there is typically a high level of black-body background radiation from this area.

The design of source 50 is advantageous, relative to source 20 (FIG. 1), in that the rotational movement of valve 64 is smooth, and vibration of the envelope is minimal. Such vibration can be a source of noise in source 20, as well as increasing the level of black-body background radiation emitted by the source itself. Furthermore, during the alternate heating and cooling of the gas in envelope 62, the walls of valve 64 stay at a substantially constant temperature, thus reducing still further the black-body background that is generated at the repetition frequency of the IR emission from the gas. The inventors have also found that by comparison with source 20, source 50 maintains the gas in envelope 62 at high pressure for a longer period, so that the duty cycle of the IR radiation is increased and, with it, the signal/noise ratio of detection of the radiation.

It is further noted that the design of alternating cylindrical valve 64 is novel in and of itself, separate and apart from the particular application for which it is used in IR source 50. Such a valve, with different holes that are aligned in alternation by the rotation of the valve with different ports in the envelope, can also be used in other applications in which a controlled, pulsatile pressure must be created.

Although in the embodiments of FIGS. 1 and 2, adiabatic compression is the preferred method of heating the gas and causing it to emit IR radiation, the principles of the present invention may also be implemented using other apparatus and methods. Any and all such methods are considered to be within the scope of the present invention. For example, in an alternative embodiment of the present invention, not shown in the figures, the gas is heated by contact with a hot foil, which is itself preferably electrically heated, in a lower section of the envelope containing the gas. The heated gas rises to an upper section of the envelope, adjacent the IR-transparent window, through which thermal radiation from the gas is emitted. After the gas cools, it returns to the lower section. Alternatively, a pump or propeller inside the envelope may propel the heated gas into the section adjacent the window and return the gas to the section adjacent the foil after the gas cools. Preferably, the window is cooled, for example, by a stream of forced air outside the envelope, to keep the window approximately at the temperature of the ambient air outside the envelope.

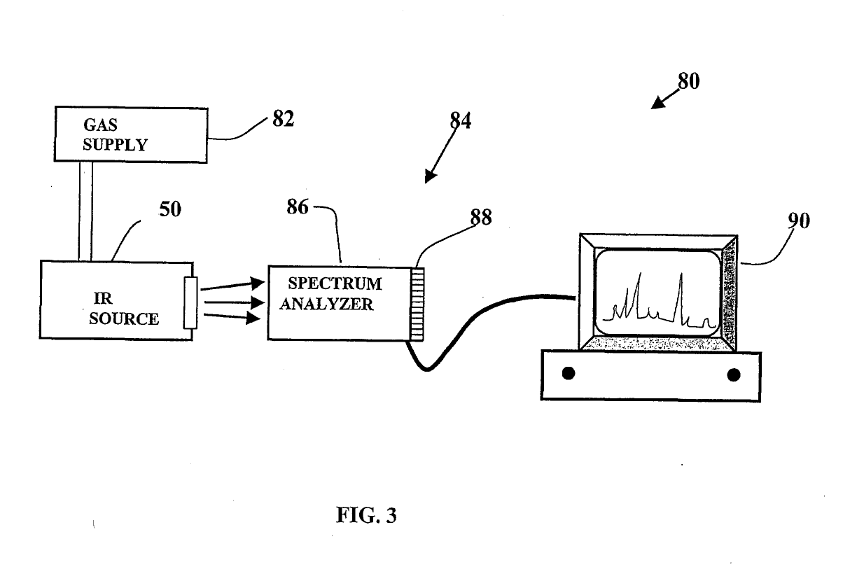

FIG. 3 is a block diagram that schematically illustrates a gas spectrograph 80 based on IR source 50, in accordance with a preferred embodiment of the present invention. The spectrograph may similarly use source 20 or another source that operates in accordance with the principles of the present invention. A gas supply 82 provides a gas (possibly including a vapor or a mixture of gases and/or vapors) to be analyzed by the spectrograph. A sample of the gas is introduced into source 50 at a desired pressure. Operation of the source, as described above, causes IR emission from the source, with a line spectrum that is characteristic of the particular gas sample.

The IR emission is input to an IR spectrometer 84. In the embodiment shown in FIG. 3, the spectrometer comprises a dispersive spectrum analyzer 86, which splits the IR emission from source 50 into its spectral constituents. Spectrum analyzer 86 typically comprises a grating monochromator or, alternatively, a prism or wedge filter, as are known in the art. An IR detector 88, preferably comprising an array of detector elements, senses the spectrally-dispersed radiation. Alternatively, spectrometer 84 may comprises an interferometer-based device, such as a Fourier Transform IR (FTIR) spectrometer, or substantially any other type of IR spectrometer known in the art.

The output of spectrometer 84 is received by a spectral processing and display unit 90. This output may be analyzed automatically or manually to identify the molecular species that are present in source 50 by their characteristic emission spectra, as well as to estimate the relative concentrations of the species that are present. Spectrograph 80 can be used in this fashion to record the emission spectrum of substantially any volatile, IR-active species in the gas or vapor phase. Emission spectrographs known in the art are typically considerably more complex and less versatile than spectrometer 84. Such spectrographs are generally limited to certain particular materials that emit radiation in a flame, for example. Therefore, prior to the present invention, only absorption spectrographs could be used to study and analyze most gas compositions. By comparison with absorption-based devices, emission spectrograph 80 has a greater signal/noise ratio, records many more IR transitions and is considerably easier to use. Spectrograph 80 can also be used to record the spectra of low-pressure vapors of molecular liquids, which are very difficult to record using absorption spectroscopy.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An infrared (IR) radiation source, comprising:
an envelope, at least a portion of which is IR transmissive; and
a molecular gas species, contained in the envelope, which gas species is thermally excited to emit IR radiation in a discrete spectrum characteristic of the species, substantially without heating the envelope.

2. A source according to claim 1, wherein the species is excited substantially without applying an electrical discharge thereto.

3. A source according to claim 1, wherein the envelope is closed off, so that gas does not flow into or out of the envelope during the excitation of the species.

4. A source according to claim 1, wherein the envelope contains a buffer gas, mixed with the molecular gas species.

5. A source according to claim 4, wherein the buffer gas comprises a rare gas.

6. A source according to claim 5, wherein the rare gas comprises argon.

7. A source according to claim 4, wherein the buffer gas is mixed with the molecular gas species in a ratio of approximately 10:1.

8. A source according to any of the preceding claims, wherein the molecular gas species is excited by adiabatic compression of the gas in the envelope.

9. A source according to claim 8, wherein the gas is alternately compressed and expanded, whereby the molecular gas species emits pulses of IR radiation.

10. A source according to claim 9, wherein the envelope comprises a piston, which compresses the gas.

11. A source according to claim 9, wherein the envelope comprises a rotating cylindrical valve, which alternately admits the gas into the envelope at a high pressure so as to compress the gas in the envelope and permits the gas to exit the envelope at a low pressure.

12. A source according to claim 8, wherein the gas is compressed by a ratio of at least 5:1.

13. A source according to claim 8, wherein the gas in the envelope is compressed and expanded multiple times.

14. A source according to any of claims 1-7, wherein the IR radiation emitted by the source is temporally modulated.

15. A source according to any of claims 1-7, wherein the gas species is thermally excited by conductive heating of the gas.

16. A source according to any of claims 1-7, wherein the molecular gas species comprises a plurality of different types of molecules, which are thermally excited to emit different, respective IR emission spectra.

17. A method for generating IR radiation, comprising:
filling an envelope, at least a portion of which is IR transmissive, with a molecular gas species; and
thermally exciting the gas species to emit IR radiation in a discrete spectrum characteristic of the species, substantially without heating the envelope.

18. A method according to claim 17, wherein exciting the gas species comprises exciting the species substantially without applying an electrical discharge thereto.

19. A method according to claim 17, and comprising closing off the envelope after it has been filled, so that gas does not flow into or out of the envelope during the excitation of the species.

20. A method according to claim 17, wherein filling the envelope comprises filling the envelope with a buffer gas, mixed with the molecular gas species.

21. A method according to claim 20, wherein the buffer gas comprises a rare gas.

22. A method according to claim 21, wherein the rare gas comprises argon.

23. A method according to claim 20, wherein filling the envelope with the buffer gas comprises mixing the buffer gas with the molecular gas species in a ratio of approximately 10:1.

24. A method according to any of claims 17-23, wherein exciting the molecular gas species comprises exciting the species by adiabatic compression of the gas in the envelope.

25. A method according to claim 24, wherein exciting the species by adiabatic compression comprises alternately compressing and expanding the gas.

26. A method according to claim 24, wherein exciting the species by adiabatic compression comprises compressing the species by at least 5:1.

27. A method according to claim 24, wherein exciting the species comprises reciprocally compressing and decompressing the gas multiple times.

28. A method according to claim 24, wherein exciting the species comprises alternately admitting the gas to an envelope at a high pressure and allowing the gas to exit the envelope at a low pressure.

29. A method according to any of claims 17-23, wherein exciting the molecular gas species comprises conductively heating the gas in the envelope.

30. A method according to any of claims 17-23, and comprising optically modulating the radiation emitted by the species.

31. A method according to any of claims 17-23, wherein filling the envelope comprises filling the envelope with a plurality of different types of molecules, whereby the emitted IR radiation includes different, respective IR emission spectra of the different types of molecules.

32. A method according to any of claims 17-23, wherein filling the envelope comprises filling the envelope with a species that is substantially isotopically pure, whereby the emitted IR radiation is used to discriminate between isotopic variants of the species.

33. Apparatus for generating infrared (IR) emission, comprising:
a cylindrical envelope, at least a portion of which is IR transmissive, the envelope having at least one inlet port in an outer surface thereof, coupled to a source of a gas at a high pressure, and at least one outlet port in the outer surface thereof, coupled to allow the gas to exit the envelope at a low pressure; and
a cylindrical valve mounted to rotate coaxially within the envelope, the valve having at least one inlet hole and at least one outlet hole, such that as the valve rotates, the inlet and outlet holes are respectively brought into alignment with the inlet and outlet ports in alternation, so as alternately to admit the gas to the envelope through the inlet port and to allow the gas to exit through the outlet port, thereby thermally exciting the gas to emit IR radiation.

34. Apparatus according to claim 33, and comprising:
a high-pressure reservoir, which serves as the source of the gas;
a low-pressure reservoir, coupled to the at least one outlet port of the envelope; and
a compressor, coupled to transfer the gas from the low-pressure reservoir to the high-pressure reservoir, whereby the gas circulates through the apparatus in a closed circuit.

35. An infrared (IR) spectrograph, comprising:
an IR source, comprising:
an envelope, at least a portion of which is IR transmissive, and which is adapted to contain a molecular gas species; and
a thermal excitation mechanism, adapted to thermally excite the gas in the envelope to emit IR radiation in a discrete spectrum comprising multiple spectral lines characteristic of the species; and
a spectrometer, coupled to receive the IR radiation emitted by the molecular gas species in the envelope and to separate the spectral lines in the radiation so as to derive an emission spectrum of the species.

36. A spectrograph according to claim 35, wherein the thermal excitation mechanism is adapted to excite the gas by adiabatic compression.

37. A spectrograph according to claim 35 or 36, wherein the spectrometer comprises a wavelength-dispersive device.

38. A spectrograph according to claim 35 or 36, wherein the spectrometer comprises an interferometric device.

39. A method for infrared (IR) spectral analysis of a molecular gas species, comprising:
filling an envelope, at least a portion of which is IR transmissive, with the molecular gas species;
thermally exciting the gas species in the envelope to emit IR radiation in a discrete spectrum comprising multiple spectral lines characteristic of the species; and
separating the spectral lines in the emitted radiation so as to derive an emission spectrum of the species.

40. A method according to claim 39, wherein thermally exciting the gas species comprises exciting the gas species by adiabatic compression.

41. A method according to claim 39 or 40, wherein separating the spectral lines comprises dispersing the spectral lines by wavelength.

42. A method according to claim 39 or 40, wherein separating the spectral lines comprises interferometrically analyzing the emitted radiation.

43. An infrared (IR) radiation source, comprising:
an envelope, at least a portion of which is IR transmissive, and which is adapted to contain a gas that comprises a molecular gas species; and
an excitation mechanism, coupled to the envelope so as to thermally excite the gas, causing the species to emit IR radiation in a discrete spectrum characteristic of the species, substantially without heating the envelope.

44. A source according to claim 43, wherein the excitation mechanism is adapted to adiabatically compress the gas in the envelope.

45. A source according to claim 44, wherein the excitation mechanism is adapted to alternately compress and expand the gas, whereby the molecular gas species emits pulses of IR radiation.

46. A source according to claim 45, wherein the envelope comprises a piston, which is operative to compress the gas.

47. A source according to claim 45, wherein the envelope comprises a rotating cylindrical valve, which is operative to alternately admit the gas into the envelope at a high pressure so as to compress the gas in the envelope and permit the gas to exit the envelope at a low pressure.
